(19) United States
(12) Patent Application Publication
(10) Pub. No.: US 2006/0072390 A1
(43) Pub. Date: Apr. 6, 2006

(54) Optical drive and controlling method for the same

(75) Inventor: Tsung Yu Ma, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/242,071

(22) Filed: Oct. 4, 2005

(30) Foreign Application Priority Data
Oct. 5, 2004 (TW) 093130152

(51) Int. Cl. G11B 7/00

(52) U.S. Cl. 369/44.27; 369/44.34

(57) ABSTRACT

An optical drive comprises a radio frequency processing unit, a memory, a digital signal processing unit, and a driving processing unit. The radio frequency processing unit enlarges a signal generated with an optical pickup and produces a tracking error signal and a servo signal. The memory saves a plurality of sled processing programs. The digital signal processing unit has a tracking processing module and a sled selecting module. The tracking processing module processes the tracking error signal and produces a tracking output signal. The sled selecting module selects one of the sled processing programs according to the servo signal for processing the tracking output signal and producing a feed output signal. The driving processing unit drives a coil motor and a sled motor respectively according to the tracking output signal and the feed output signal.

### BACKGROUND OF THE INVENTION

1. Field of Invention

The invention relates to an optical drive and a controlling method for the optical drive.

2. Related Art

Because of the increasing capacity of optical storage media and desires for fast accessing the optical storage media, the track pitch of the optical storage media is formed thinner, and the spindle motor revolves rapidly in the optical drive. For correctly accessing the optical storage media, it is necessary to precisely control the optical pickup of the optical drive when the track pitch is thinner and the motor rotates rapidly.

As shown in FIG. 1A, an optical storage medium 11 is placed on a holder 121 (the optical storage medium is partially shown in FIG. 1A). The medium 11 is revolved by a spindle motor 122. The optical pickup 141 is installed on a pickup base 131. The optical pickup 141 emits laser beams to the medium 11 and receives the reflected laser beams from the medium 11 for accessing data. The pickup base 131 is slid on a guideway (rail) 133 and connects to a rack 132. The sled motor 151 revolves a gear 152, which couples with the rack 132. Therefore, the pickup base 131 is slid along the radial direction of the medium 11 on the guideway (rail) 133. A coil motor 142 is installed on the pickup base 131 and is provided to adjust an angle with which the optical pickup 141 align the medium 11. The position of the optical pickup 141 and the focus of the laser beams are adjusted with the sled motor 151 and the coil motor 142. Consequently, the optical pickup 141 is able to access each track on the medium 11.

With reference to FIG. 1B, the radio frequency processor 161 enlarges the signal 171, which is read by the optical pickup 141, and produces a tracking error signal 172 and a servo signal 173 according to the signal 171. A digital signal processor 162 processes the tracking error signal 172 and the servo signal 173 with a constant module, then the digital signal processor 162 produces a tracking output signal 174 and a feed motor signal 175. A driving chip 163 controls the coil motor 142 and the sled motor 151 according to the tracking output signal 174 and the feed motor signal 175.

Referring to FIG. 1A, FIG. 1B and FIG. 1C, the reflected laser beam received by the optical pickup 141 comprises a 0 order reflected laser beam 181, a −1 order reflected laser beam 182, and a +1 order reflected laser beam 183. The 0 order reflected laser beam 181 is divided into four areas A, B, C and D. Several signals for servo control are produced after an optical electric element processes the combination of the laser beam intensity in each area. The tracking error signal 172 described above is defined as (A+C)−(B+D) and it represents the intensity, which is the difference between the sum of the laser beam intensities in the area A and the area C and the sum of the laser beam intensities in the area B and the area D. The servo signal 173 described above is defined as (A+B)−(C+D) and it represents the intensity, which is the difference between the sum of the laser beam intensities in the area A and the area B and the sum of the laser beam intensities in the area C and the area D.

As shown in FIG. 1B and FIG. 1D (the optical storage medium is partially shown in FIG. 1D), the coil motor 142 and the sled motor 151 are controlled by the method described accompanying with FIG. 1B. Because of the accessing ratio of the optical drive and the distinct components, different optical drives have different characteristics. Herein, the digital signal processor 162 processes the tracking error signal 172 and the servo signal 173 by only one constant module. Therefore, the coil motor 142 is not able to successfully correct the tilted angle of the pickup 141. Consequently, if the tilt of pickup 141 occurs, the tilt is difficult to correct and the tile limits the accessing ability of the pickup 141.

It is therefore a subjective of the invention to provide an optical and a controlling method for the optical drive, which processes the tracking error signal and the servo signal by multi modules, and appropriately adjusts the tilt of the optical pickup.

### SUMMARY OF THE INVENTION

In view of the foregoing, the invention is to provide an optical drive and its controlling method.

To achieve the above, an optical drive of the invention comprises a radio frequency processing unit, a memory, a digital signal processing unit, and a driving processing unit. The optical drive operates when an optical pickup reads an optical storage medium to generate a signal. A coil motor adjusts the optical pickup to align the optical storage medium with an angle and a sled motor moves the optical pickup along a radial direction of the optical storage medium. The radio frequency processing unit enlarges the signal and produces a tracking error signal and a servo signal. The memory saves a plurality of sled processing programs. The digital signal processing unit has a tracking processing module and a sled selecting module. The tracking processing module processes the tracking error signal and produces a tracking output signal. The sled selecting module selects one of the sled processing programs from the memory according to the servo signal, and the selected sled processing module is executed to process the tracking output signal and to produce a feed output signal. The driving processing unit drives the coil motor and the sled motor respectively according to the tracking output signal and the feed output signal.

To achieve the above, the invention also provides an optical drive, which operates when an optical pickup reads an optical storage medium to generate a signal. A coil motor adjusts the optical pickup to align the optical storage medium with an angle and a sled motor moves the optical pickup along a radial direction of the optical storage medium. The optical drive comprises a radio frequency processing unit, a digital signal processing unit, and a driving processing unit. The radio frequency processing unit enlarges the signal and produces a tracking error signal and a servo signal. The digital signal processing unit has a tracking processing module, a plurality of sled processing modules and a multiplexer. The tracking processing module processes the tracking error signal and produces a tracking output signal. Each of the sled processing modules process the tracking output signal and produce a feed output signal. The multiplexer selects one of the sled processing modules according to the servo signal. The driving processing unit drives the coil motor and the sled motor respectively according to the tracking output signal and the feed output signal.

To achieve the above, the invention further provides a controlling method for an optical drive. The optical drive operates when an optical pickup reads an optical storage medium to generate a signal. A coil motor adjusts the optical pickup to align the optical storage medium with an angle and a sled motor moves the optical pickup along a radial direction of the optical storage medium. The controlling method comprises the following steps of: enlarging the signal and producing a tracking error signal and a servo signal, processing the tracking error signal and producing a tracking output signal, selecting a sled processing module according to the servo signal, executing the selected sled processing module to process the tracking output signal and to produce a feed output signal, and driving the coil motor and the sled motor respectively according to the tracking output signal and the feed output signal.

As mentioned above, since the optical drive comprises at least one sled processing module, which processes the tracking error signal and the servo signal, so the tilt of the optical pickup is applicably adjusted. In addition, the controlling method employs at least one sled processing module for processing the tracking error signal and the servo signal, so as to appropriately adjust the tilt of the optical pickup.

### BRIEF DESCRIPTION OF THE DRAWINGS

The invention will become more fully understood from the detailed description given herein below illustration only, and thus is not limitative of the present invention, and wherein:

FIG. 1A is a schematic diagram showing the conventional optical drive;

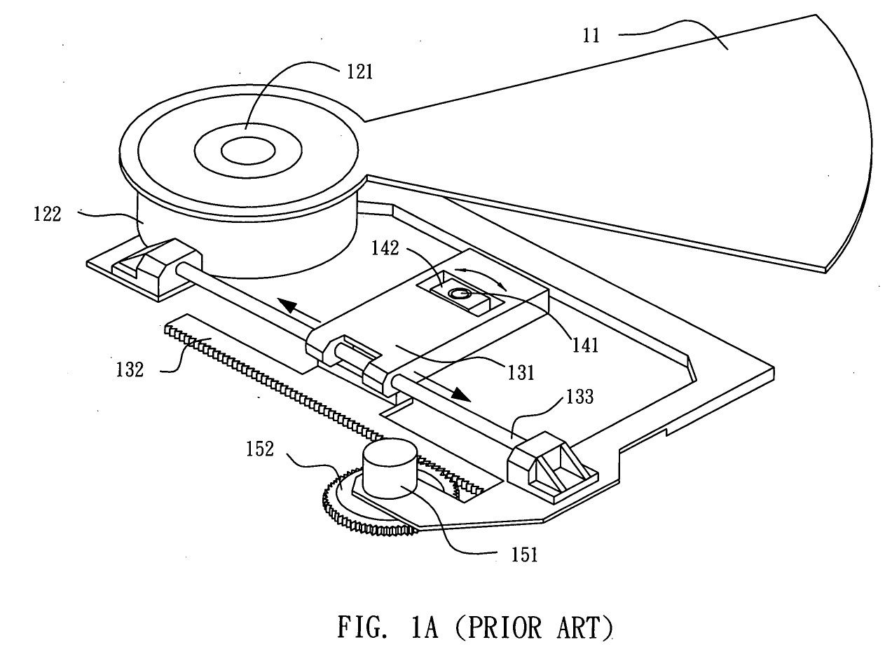

FIG. 1B is a block diagram showing the conventional optical drive;

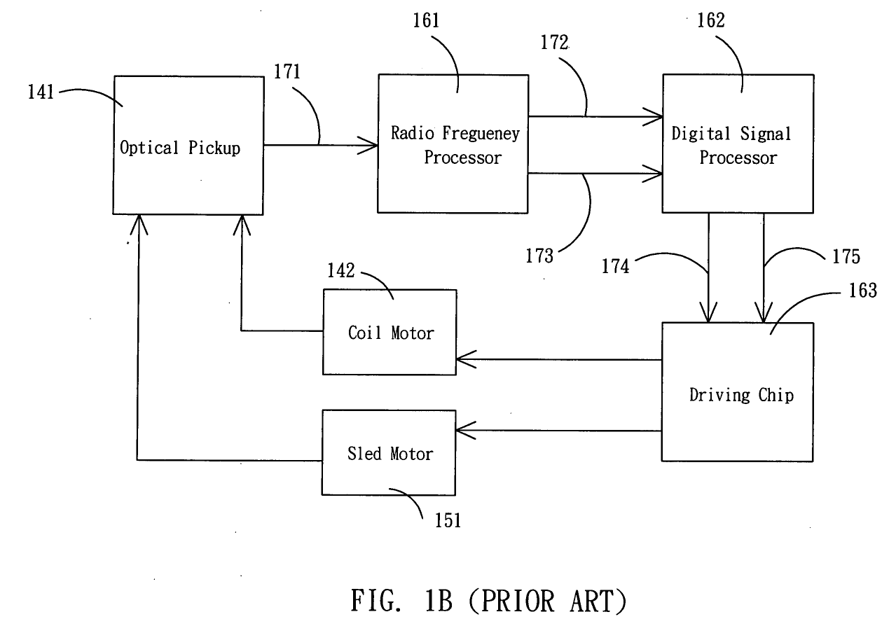

FIG. 1C is a schematic diagram showing the conventional optical drive, wherein the reflected laser from the optical storage medium comprises three laser beams;

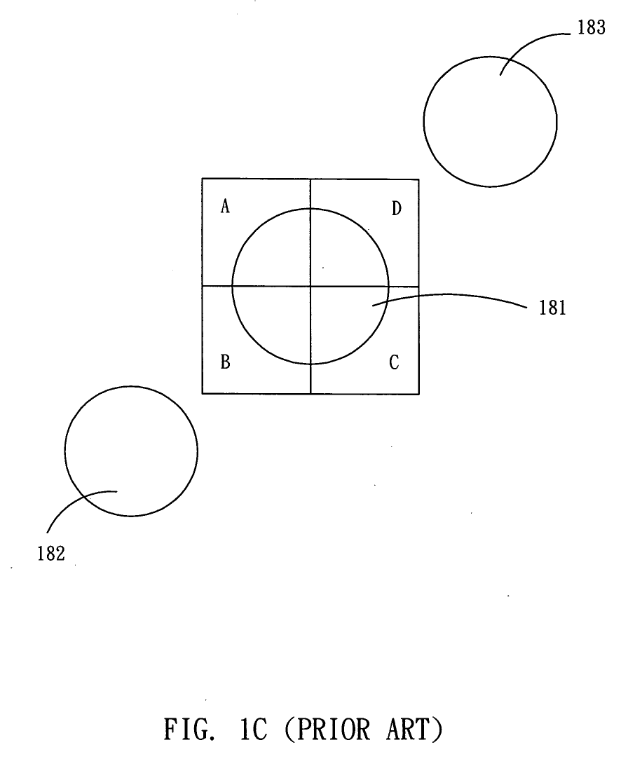

FIG. 1D is a schematic diagram showing the conventional optical drive, wherein the optical pickup is tilted;

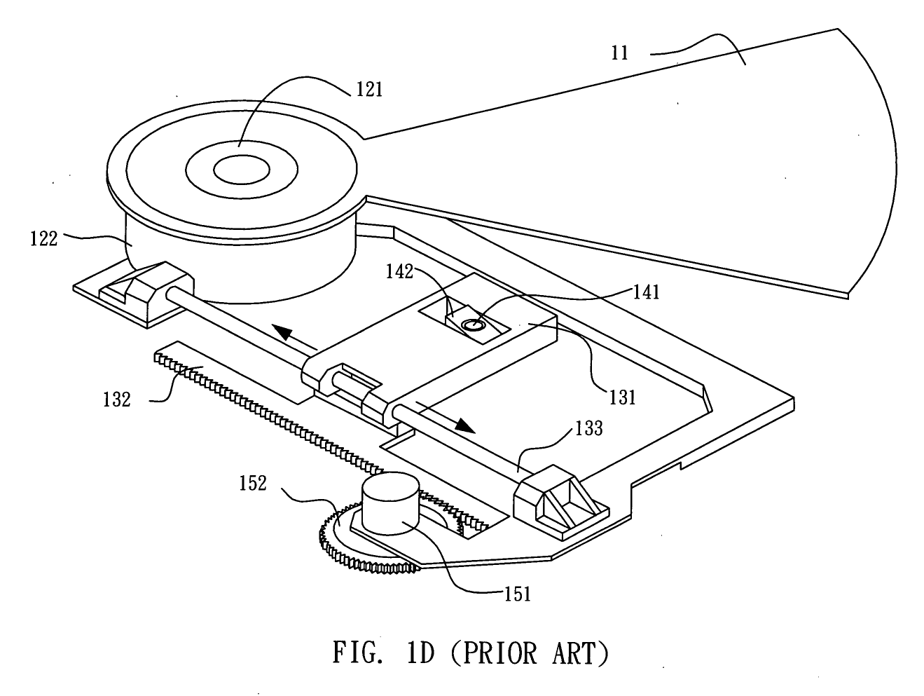

FIG. 2 is a block diagram showing an optical drive according to a preferred embodiment of the invention;

FIG. 3A is a schematic diagram showing an optical drive according to a preferred embodiment of the invention, wherein the optical pickup is not tilted;

FIG. 3B is a schematic diagram showing an optical drive according to a preferred embodiment of the invention, wherein the optical pickup is tilted;

FIG. 3C is a schematic diagram showing an optical drive according to a preferred embodiment of the invention, wherein the optical pickup is tilted-corrected;

FIG. 4 is a block diagram showing an optical drive according to another preferred embodiment of the invention; and

FIG. 5 is a flow chart showing a controlling method for an optical drive according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

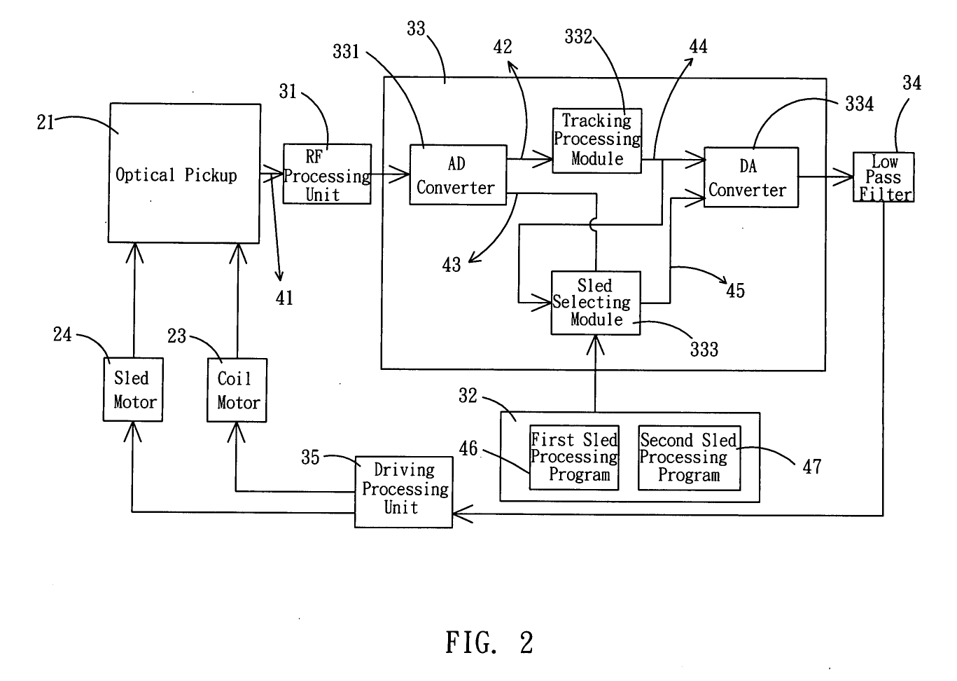

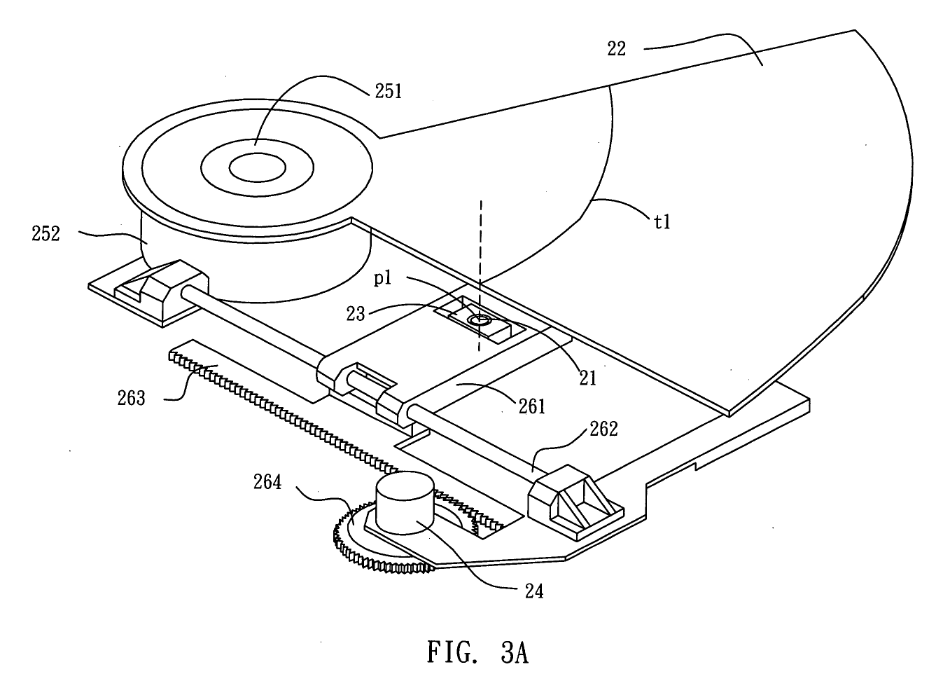

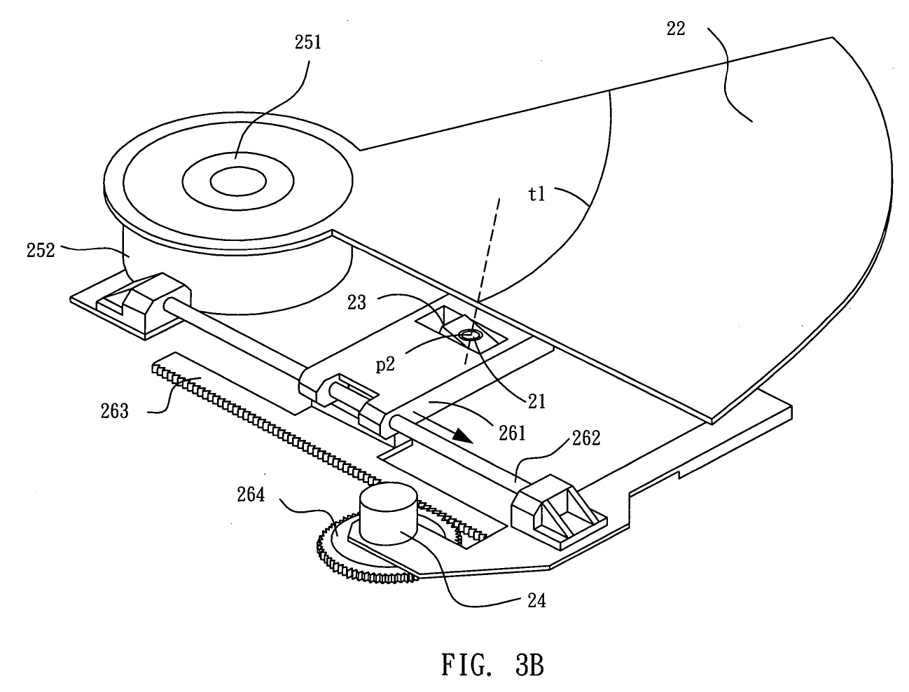

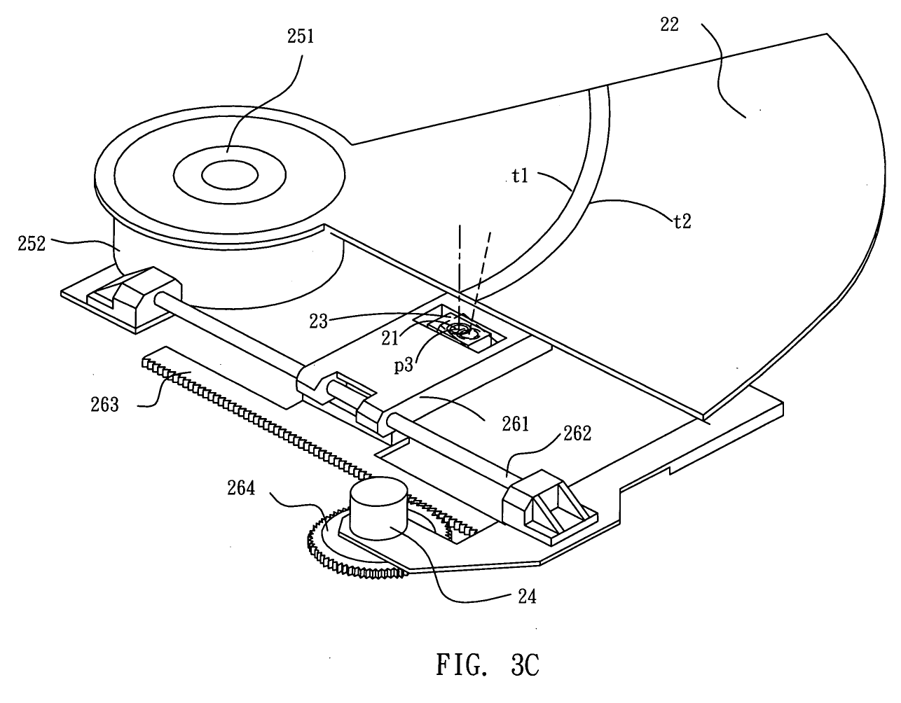

With reference to FIG. 2 and FIG. 3A, an optical drive according to a preferred embodiment of the invention operates when an optical pickup 21 reads an optical storage medium 22 to generate a signal 41, wherein a coil motor 23 adjusts the optical pickup 21 to align the optical storage medium 22 with an angle and a sled motor 24 moves the optical pickup 21 along a radial direction of the optical storage medium 22. The optical drive comprises a radio frequency processing unit 31, a memory 32, a digital signal processing unit 33, a low pass filter 34 and a driving processing unit 35. The radio frequency processing unit 31, the digital signal processing unit 33, the low pass filter 34, the driving processing unit 35, the coil motor 23, the sled motor 24, and the optical pickup 21 compose a feedback control loop.

The radio frequency processing unit 31 enlarges the signal 41 read by the optical pickup 21 and produces a tracking error signal 42 and a servo signal 43. The memory 32 saves a first sled processing program 46 and a second sled processing program 47, which are provided to be suitably selected by the digital signal processing unit 33. The sled processing program 46 and the second sled processing program 47 are executed to produce different output signals according to the same input signal. Therefore, the first sled processing program 46 and the second sled processing program 47 are selected and executed to applicably control driving processing unit 35 and the sled motor 24 at different situations. The digital signal processing unit 33 has an analog to digital converter (AD converter) 331, a tracking processing module 332, a sled selecting module 333, and a digital to analog converter (DA converter) 334. The analog to digital converter 331 converts the tracking error signal 42 and the servo signal 43 from analog to digital. The tracking processing module 332 processes the tracking error signal 42 and produces a tracking output signal 44. The sled selecting module 333 selects one of the first sled processing program 46 and the second sled processing program 47 from the memory 32 according to the servo signal 43, and executes the selected one to process the tracking output signal 44 to produce a feed output signal 45. The digital to analog converter 334 converts the tracking output signal 44 and the feed output signal 45 from digital to analog. The low pass filter 34 filters off a high frequency signal within the tracking output signal 44 and the feed output signal 45. The driving processing unit 35 drives the coil motor 23 and the sled motor 24 respectively according to the tracking output signal 44 and the feed output signal 45.

FIGS. 3A to 3C show a specific optical drive according to a preferred embodiment of the invention. In FIGS. 3A to 3C, the optical storage medium 22 is placed on the holder 251 (the optical storage medium 22 is partially shown). The optical storage medium 22 is revolved with a spindle motor 252. The optical pickup 21 is installed on a pickup base 261. The optical pickup 21 emits laser beams to the medium 22 and receives the reflected beams from the medium 22 for accessing data. The pickup base 261 is slid on a guideway (rail) 262 and connects to a rack 263. The sled motor 24 revolves a gear 264, which couple with the rack 263, and therefore the pickup base 261 is slid along the radial direction of the medium 22 on a guideway (rail) 262. A coil motor 23 is installed on the pickup base 261 and is provided to adjust an angle with which the pickup 21 align the medium 22.

Referring to FIG. 2 and FIG. 3A, the optical pickup 21 is not tilt from the optical storage medium 22 and the laser beams focus on the track t1 (shown by the arc) when the optical pickup 21 is moved to the position p1 directly under the track t1. After the radio frequency processing unit 31 and the analog to digital converter 331 described above enlarges the signal 41 read by the optical pickup 21 and produces a tracking error signal 42 and a servo signal 43, the tracking error signal 42 is processed to produce a tracking output signal 44 by the tracking processing module 332. Otherwise, because the optical pickup 21 is not tilt from the optical storage medium 22, the value of the servo signal 43 is not larger than a threshold T. The sled selecting module 333 selects the first sled processing program 46 from the memory 32 according to the servo signal 43, and the selected first sled processing program 46 is executed to process the tracking output signal 44 to produce a feed output signal 45. Then, the driving processing unit 35 drives the coil motor 23 and the sled motor 24 according to the tracking output signal 44 and the feed output signal 45. It is assure that optical pickup 21 is moved to the position p1 directly under the track t1.

Referring to FIG. 3A, the optical pickup 21 is tilted from the optical storage medium 22 and the laser beams focus on the track t1 (shown by the arc) when the optical pickup 21 is moved to the position p2 below the track t1. After the radio frequency processing unit 31 and the analog to digital converter 331 produces the tracking error signal 42 and the servo signal 43, the tracking error signal 42 is processed to produce a tracking output signal 44 by the tracking processing module 332. Otherwise, because the optical pickup 21 is tilted from the optical storage medium 22, the value of the servo signal 43 is larger than the threshold T. The sled selecting module 333 selects the second sled processing program 47 from the memory 32 according to the servo signal 43 and executes the second sled processing program 47 to process the tracking output signal 44 to produce a feed output signal 45. Then, the driving processing unit 35 controls the sled motor 24 according to the feed output signal 45, so that that optical pickup 21 is moved to the position p3 directly under the track t1 (as shown in FIG. 3C).

As shown in FIG. 2 and FIG. 3C, the optical pickup 21 is moved to the position p3 directly under the track t1, and the optical pickup 21 is tilted from the optical storage medium 22. Therefore, the laser beam from the optical pickup 21 focuses on the track t2 (shown by the arc), not on the track t1 as desired. So, the tilt angle of the optical pickup 21 is necessary to be adjusted by the coil motor 23, then the laser beam from the optical pickup 21 focuses on the track t1. Herein, because the value of the tracking error signal 42 increases, the tracking output signal 44 produced by the tracking processing module 332 is also increased. Therefore, the coil motor 23 is driven so that the optical pickup 21 is not tilted and the laser beam from it correctly focuses on the track t1.

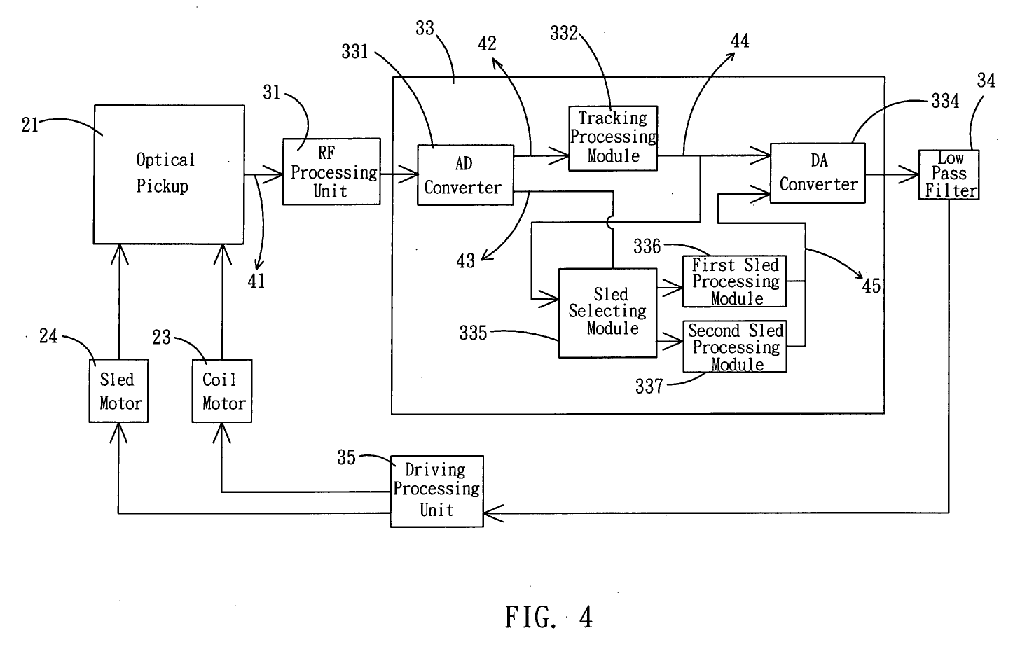

FIG. 4 shows an optical drive according to another preferred embodiment of the invention. The optical drive operates when an optical pickup 21 reads an optical storage medium 22 to generate a signal 41, wherein a coil motor 23 adjusts the optical pickup 21 to align the optical storage medium 22 with an angle and a sled motor 24 moves the optical pickup 21 along a radial direction of the optical storage medium 22. The optical drive comprises a radio frequency processing unit 31, a digital signal processing unit 33, a low pass filter 34 and a driving processing unit 35. The digital signal processing unit 33 has an analog to digital converter (AD converter) 331, a tracking processing module 332, a sled selecting module (ex: multiplexer) 335, a first sled processing module 336, a second sled processing module 337, and a digital to analog converter 334. The radio frequency processing unit 31, the digital signal processing unit 33, the low pass filter 34, the driving processing unit 35, the coil motor 23, the sled motor 24, and the optical pickup 21 compose a feedback control loop.

In this embodiment, the features and functions of the radio frequency processing unit 31, the analog to digital converter (AD converter) 331, the tracking processing module 332, the low pass filter 34, and the driving processing unit 35 are the same as the previously mentioned in the embodiment referring to FIG. 2, so that the detailed descriptions are omitted for concise purpose. The sled selecting module (multiplexer) 335 selects the first sled processing module 336 or the second sled processing module 337 according to the servo signal 43, and the selected sled processing module is executed to process the tracking output signal 44 to produce a feed output signal 45. The first sled processing module 336 and the second sled processing module 337 produces different output signals according to the same input signal. Therefore, the first sled processing module 336 and the second sled processing module 337 are selected and executed to applicably control driving processing unit 35 and the sled motor 24 at different situations. In this embodiment, the sled selecting module (multiplexer) 335, the first sled processing module 336 and the second sled processing module 337 individually have the same functions with the sled processing module 333, the first sled processing program 46 and the second sled processing program 47 referring to the specific embodiment in FIG. 3A and FIG. 3B, so the detailed descriptions are omitted for concise purpose.

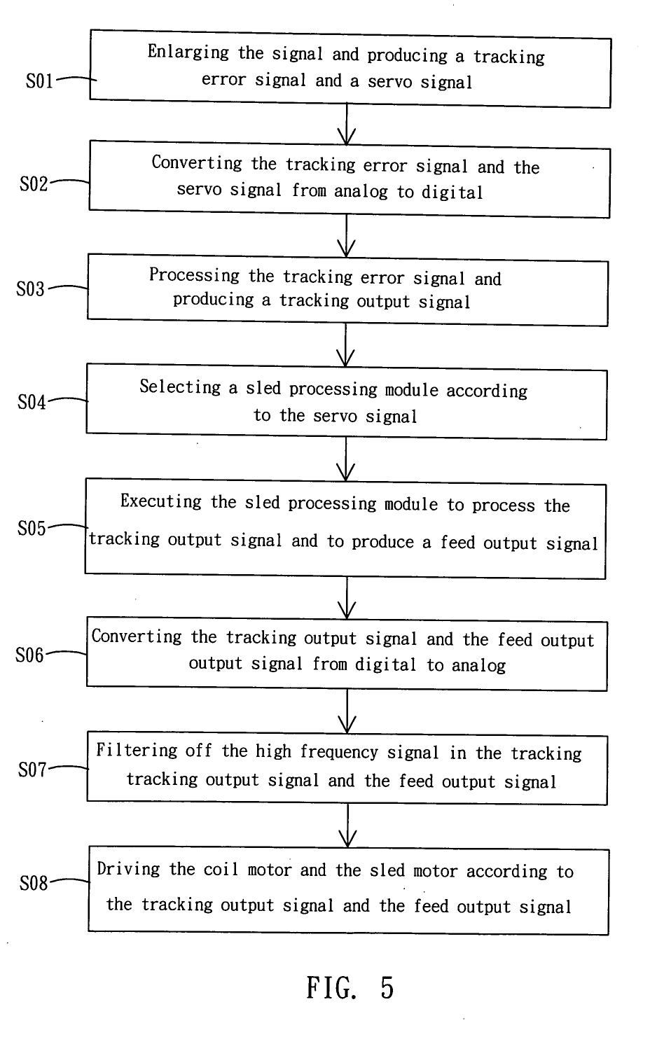

FIG. 5 shows a controlling method for a optical drive according to a preferred embodiment of the invention. The optical drive to be controlled operates when an optical pickup reads an optical storage medium to generate a signal, wherein a coil motor adjusts the optical pickup to align the optical storage medium with an angle and a sled motor moves the optical pickup along a radial direction of the optical storage medium. The controlling method comprises the following steps of: enlarging the signal and producing a tracking error signal and a servo signal, converting the tracking error signal and the servo signal from analog to digital, processing the tracking error signal and producing a tracking output signal, selecting a sled processing module according to the servo signal, executing the sled processing module to process the tracking output signal and to produce a feed output signal, converting the tracking output signal and the feed output signal from digital to analog, filtering off the high frequency signal in the tracking output signal and the feed output signal, and driving the coil motor and the sled motor respectively according to the tracking output signal and the feed output signal.

The detailed descriptions of the controlling method in the embodiment have been illustrated in the previous embodiments referring to FIG. 2 and FIGS. 3A to 3C. Therefore, the detailed descriptions of the controlling method are not repeated hereinafter.

As mentioned above, the optical drive comprise at least one sled processing module, which processes the tracking error signal and the servo signal, so the tilt of the optical pickup is applicably adjusted. In addition, the controlling method employs at least one sled processing module for processing the tracking error signal and the servo signal, so as to appropriately adjust the tilt of the optical pickup.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical drive, which operates when an optical pickup reads an optical storage medium to generate a signal, wherein a coil motor adjusts the optical pickup to align the optical storage medium with an angle and a sled motor moves the optical pickup along a radial direction of the optical storage medium, the optical drive comprising:
a radio frequency processing unit enlarging the signal and producing a tracking error signal and a servo signal;
a memory saving a plurality of sled processing programs;
a digital signal processing unit having a tracking processing module and a sled selecting module, wherein the tracking processing module processes the tracking error signal and produces a tracking output signal, the sled selecting module selects one of the sled processing programs from the memory according to the servo signal, and the selected sled processing program is executed to process the tracking output signal and to produce a feed output signal; and
a driving processing unit driving the coil motor and the sled motor respectively according to the tracking output signal and the feed output signal.

2. The optical drive of claim 1, wherein the radio frequency processing unit, the digital signal processing unit, the driving processing unit, the coil motor, the sled motor, and the optical pickup compose a feedback control loop.

3. The optical drive of claim 1, further comprising:
a low pass filter filtering off a high frequency signal within the tracking output signal and the feed output signal.

4. The optical drive of claim 1, wherein the digital signal processing unit further comprises:
an analog to digital converter converting the tracking error signal and the servo signal from analog to digital; and
a digital to analog converter converting the tracking output signal and the feed output signal from digital to analog.

5. An optical drive, which operates when an optical pickup reads an optical storage medium to generate a signal, wherein a coil motor adjusts the optical pickup to align the optical storage medium with an angle and a sled motor moves the optical pickup along a radial direction of the optical storage medium, the optical drive comprising:
a radio frequency processing unit enlarging the signal and producing a tracking error signal and a servo signal;
a digital signal processing unit having a tracking processing module, a plurality of sled processing modules and a multiplexer, wherein the tracking processing module processes the tracking error signal and produces a tracking output signal, each of the sled processing modules processes the tracking output signal and produces a feed output signal, and the multiplexer selects one of the sled processing modules according to the servo signal; and
a driving processing unit driving the coil motor and the sled motor respectively according to the tracking output signal and the feed output signal.

6. The optical drive of claim 5, wherein the radio frequency processing unit, the digital signal processing unit, the driving processing unit, the coil motor, the sled motor, and the optical pickup compose a feedback control loop.

7. The optical drive of claim 5, further comprising:
a low pass filter filtering off a high frequency signal within the tracking output signal and the feed output signal.

8. The optical drive of claim 5, wherein the digital signal processing unit further comprises:
an analog to digital converter converting the tracking error signal and the servo signal from analog to digital; and
a digital to analog converter converting the tracking output signal and the feed output signal from digital to analog.

9. A controlling method for an optical drive, which operates when an optical pickup reads an optical storage medium to generate a signal, wherein a coil motor adjusts the optical pickup to align the optical storage medium with an angle and a sled motor moves the optical pickup along a radial direction of the optical storage medium, the controlling method comprising:
enlarging the signal and producing a tracking error signal and a servo signal;
processing the tracking error signal and producing a tracking output signal;
selecting a sled processing module according to the servo signal;
executing the selected sled processing module to process the tracking output signal and to produce a feed output signal; and
driving the coil motor and the sled motor according to the tracking output signal and the feed output signal.

10. The controlling method of claim 9, further comprises:
filtering off a high frequency signal within the tracking output signal and the feed output signal.

11. The controlling method of claim 9, further comprises:
converting the tracking error signal and the servo signal from analog to digital; and
converting the tracking output signal and the feed output signal from digital to analog.
